(19) United States
(12) Patent Application Publication
(10) Pub. No.: US 2022/0180092 A1
(43) Pub. Date: Jun. 9, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Arihito TAKAGI, Kanagawa (JP)

(73) Assignee: FUJIFILM Business Innovation Corp., Tokyo (JP)

(21) Appl. No.: 17/335,153

(22) Filed: Jun. 1, 2021

(30) Foreign Application Priority Data
Dec. 9, 2020 (JP) 2020-204534

(51) Int. Cl. G06K 9/00; G06K 9/46; G06F 40/20

(52) U.S. Cl. CPC G06K 9/00456; G06K 2209/01; G06F 40/20; G06K 9/46

(57) ABSTRACT

An information processing apparatus includes a processor configured to: acquire data including texts extracted from an image obtained by reading a document; and display an inadequacy in the data checked by a user and an inadequacy in the data detected by a system in different formats.

### CROSS-REFERENCE TO RELATED APPLICATIONS

This application is based on and claims priority under 35 USC 119 from Japanese Patent Application No. 2020-204534 filed Dec. 9, 2020.

### BACKGROUND

### (i) Technical Field

The present disclosure relates to an information processing apparatus and a non-transitory computer readable medium storing an information processing program.

### (ii) Related Art

Japanese Unexamined Patent Application Publication No. 2019-67145 discloses a technology relating to an information processing apparatus including an imaging device. The information processing apparatus includes a partial imager that images a part of a form by using the imaging device, an acquirer that acquires electronic data indicating a partial form image obtained by the partial imager, an error determiner that determines an error in a written item in the acquired electronic data, and an error display that identifies and displays a portion determined as the error.

### SUMMARY

Aspects of non-limiting embodiments of the present disclosure relate to the following circumstances. In recent years, there has been provided a system in which texts are extracted from an image obtained by reading a document or the like by a multifunction peripheral, the extracted texts are processed into data, and the data is stored in a cloud server. In this system, a user checks inadequacy by sight, and the system automatically checks inadequacy. In response to detection of inadequacy in the data, the user may be notified about the detection of inadequacy in any case.

The notified user may have difficulty in discriminating at a glance whether the inadequacy has been found by the user or the system.

Aspects of non-limiting embodiments of the present disclosure therefore relate to an information processing apparatus and a non-transitory computer readable medium storing an information processing program, in which a user notified about inadequacy in image data may discriminate whether the inadequacy has been found by the user or a system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: acquire data including texts extracted from an image obtained by reading a document; and display an inadequacy in the data checked by a user and an inadequacy in the data detected by a system in different formats.

### BRIEF DESCRIPTION OF THE DRAWINGS

An exemplary embodiment of the present disclosure will be described in detail based on the following figures, wherein:

FIG. 1 is a block diagram illustrating an example of the overall configuration of a form system according to an exemplary embodiment;

FIG. 2 is a block diagram illustrating an example of the hardware configuration of an information processing apparatus according to the exemplary embodiment;

FIG. 3 is a block diagram illustrating an example of the functional configuration of the information processing apparatus according to the exemplary embodiment;

FIG. 4 illustrates an example of a list screen according to the exemplary embodiment;

FIG. 5 illustrates an example of a detail screen for description of check and correction according to the exemplary embodiment;

FIG. 6 illustrates an example of a detail screen for description of a user message according to the exemplary embodiment;

FIG. 7 is a flowchart illustrating an example of a flow of processes for displaying the list screen according to the exemplary embodiment; and

FIG. 8 is a flowchart illustrating an example of a flow of processes for displaying the detail screen according to the exemplary embodiment.

### DETAILED DESCRIPTION

An exemplary embodiment of the present disclosure is described below in detail with reference to the drawings.

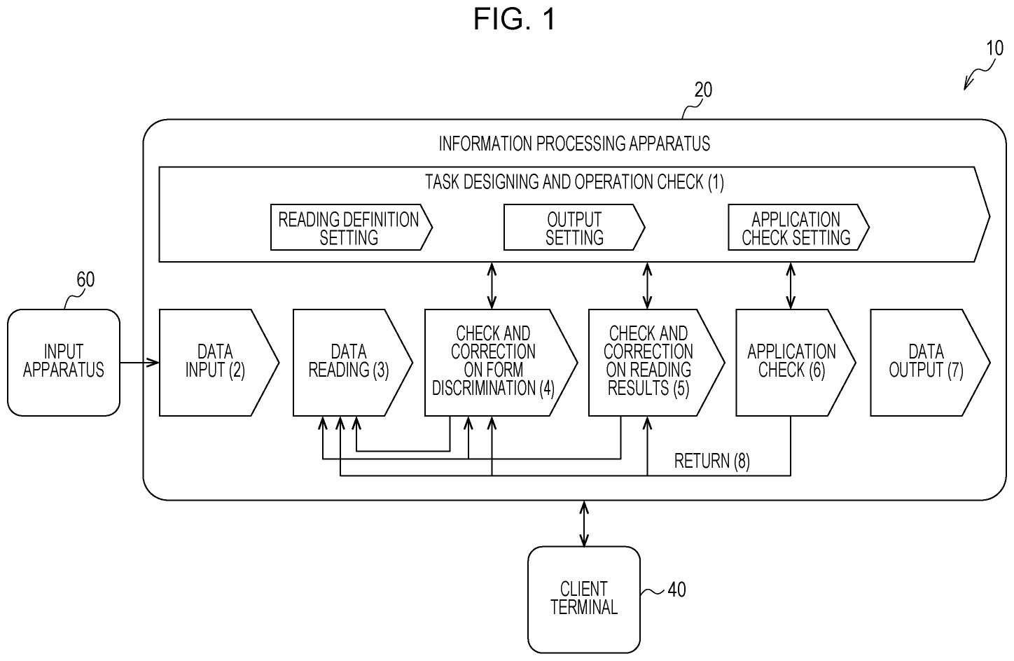

FIG. 1 illustrates the overall configuration of a form system 10 according to this exemplary embodiment. As illustrated in FIG. 1, the form system 10 includes an information processing apparatus 20, a client terminal 40, and an input apparatus 60. Those apparatuses are connected to a network (not illustrated) and communicable with each other via the network. Examples of the network include the Internet, a local area network (LAN), and a wide area network (WAN).

The information processing apparatus 20 manages a flow of sequential processes that involve executing optical character recognition (OCR) on image data of a plurality of documents including forms input via the input apparatus 60 and outputting OCR results to a preset destination. The specific configuration and operation of the information processing apparatus 20 are described later.

The client terminal 40 transmits various OCR-related instructions to the information processing apparatus 20. Examples of the instructions include an instruction to start information reading from image data, and an instruction to display the information read from the image data. The client terminal 40 displays various types of information such as results and notifications related to the OCR executed by the information processing apparatus 20 in response to the received instructions. Examples of the client terminal 40 include a server computer and a general computer such as a personal computer (PC). Although FIG. 1 illustrates one client terminal 40, the number of client terminals 40 is not limited thereto, and a plurality of client terminals 40 may be prepared. For example, the client terminals 40 may be used selectively for individual processes.

The input apparatus 60 inputs image data for OCR to the information processing apparatus 20. Examples of the input apparatus 60 include a server computer, a general computer such as a PC, and an image forming apparatus having a scanning function, a printing function, and a facsimile function. In addition to the input apparatus 60, the client terminal 40 may also input image data to the information processing apparatus 20.

Next, an overview of the form system 10 is described.

In the form system 10, the information processing apparatus 20 executes OCR on image data input via the input apparatus 60, and outputs OCR results to a preset destination.

In the OCR, the information processing apparatus 20 manages various processes such as (1) task designing and operation check, (2) data input, (3) data reading, (4) check and correction on form discrimination, (5) check and correction on reading results, (6) application check, (7) data output, and (8) return. In this exemplary embodiment, the OCR includes a post-process such as correction of texts as well as the process of reading texts and symbols from image data.

As an example of the management of the processes, the information processing apparatus 20 automatically executes (1) task designing and operation check, (2) data input, (3) data reading, (6) application check, and (7) data output. As an example of the management of the processes, a user inputs instructions via the client terminal 40 to execute (4) check and correction on form discrimination and (5) check and correction on reading results. As an example of the management of the processes, the information processing apparatus 20 may automatically execute (8) return or the user may input an instruction via the client terminal 40 to execute (8) return.

In (1) task designing and operation check, job rules including reading definition setting, output setting, and application check setting are created. In the reading definition setting, for example, an information reading range on image data is set for “(3) data reading”. More specifically, such a definition is set that a value of an item is read from a portion on the right of a key item. In the output setting, for example, a format and a destination of a data file to be output in “(7) data output” are set. In the application check setting, formats of a form to be subjected to “(6) application check”, such as required items and the number of imputable characters, are set.

In (2) data input, image data input from the input apparatus 60 is received. The received image data is registered as a job, which is a unit of execution of “(3) data reading”.

In (3) data reading, information is read from the image data in the job based on its job rule selected by the user from among the job rules created in “(1) task designing and operation check”. For example, this process involves discrimination of a form indicated by the image data in the job (hereinafter referred to as “form discrimination”) and reading of texts and symbols in the reading range.

In (4) check and correction on form discrimination, the image data in the job is split into records indicating the form in the job based on a result of the form discrimination executed in “(3) data reading”. In this process, the records are displayed and user's check and correction on the form discrimination are accepted.

In (5) check and correction on reading results, results of the reading of the texts and symbols in the reading range in “(3) data reading” are displayed and user's check and correction on the reading results are accepted.

In (6) application check, errors in the preceding processes in the job are detected based on the application check setting included in the job rule selected by the user from among the job rules created in “(1) task designing and operation check”. Detection results may be presented to the user.

In (7) data output, output data in the job is created based on the output setting included in the job rule selected by the user from among the job rules created in “(1) task designing and operation check”, and the created output data is output to the preset destination.

In (8) return, any process executed in the OCR is returned to a process at one or more steps earlier. For example, the process is returned in response to a user's instruction from the client terminal 40 during execution of “(4) check and correction on form discrimination” or “(5) check and correction on reading results”. For example, the process is returned in response to an administrator's instruction from the client terminal 40 depending on a result of administrator's check between “(6) application check” and “(7) data output”.

In the OCR, “(1) task designing and operation check” are executed prior to execution of “(3) data reading” and the subsequent processes, that is, prior to operation of the form system 10. Alternatively, “(1) task designing and operation check” may be executed during the operation of the form system 10 that is executing “(3) data reading” and the subsequent processes. For example, the job rules created in “(1) task designing and operation check” prior to the operation of the form system 10 may be revised as appropriate depending on results of “(5) check and correction on reading results” during the operation of the form system 10.

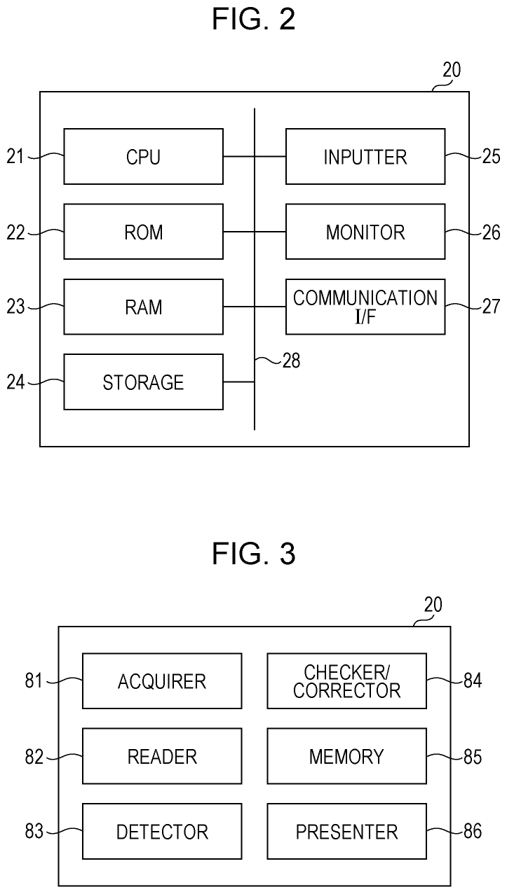

Next, the configuration of the information processing apparatus 20 is described with reference to FIG. 2. FIG. 2 is a block diagram illustrating an example of the hardware configuration of the information processing apparatus 20 according to this exemplary embodiment. For example, the information processing apparatus 20 according to this exemplary embodiment is, but not limited to, a terminal such as a personal computer or a server. The information processing apparatus 20 may be mounted on an image forming apparatus such as a multifunction peripheral.

As illustrated in FIG. 2, the information processing apparatus 20 according to this exemplary embodiment includes a central processing unit (CPU) 21, a read only memory (ROM) 22, a random access memory (RAM) 23, a storage 24, an inputter 25, a monitor 26, and a communication interface (I/F) 27. The CPU 21, the ROM 22, the RAM 23, the storage 24, the inputter 25, the monitor 26, and the communication I/F 27 are connected by a bus 28. The CPU 21 is an example of a processor.

The CPU 21 controls the overall information processing apparatus 20. The ROM 22 stores data and various programs including an information processing program according to this exemplary embodiment. The RAM 23 serves as a working area during execution of the programs. The CPU 21 executes the programs stored in the ROM 22 by loading the programs on the RAM 23, thereby executing a process of displaying texts read from image data. Examples of the storage 24 include a hard disk drive (HDD), a solid state drive (SSD), and a flash memory. The storage 24 may store the information processing program and the like. Examples of the inputter 25 include a mouse and a keyboard that receive operation of inputting texts and the like. The monitor 26 displays a list and details of read data. The communication I/F 27 transmits and receives data.

Next, the functional configuration of the information processing apparatus 20 is described with reference to FIG. 3. FIG. 3 is a block diagram illustrating an example of the functional configuration of the information processing apparatus 20 according to this exemplary embodiment.

As illustrated in FIG. 3, the information processing apparatus 20 includes an acquirer 81, a reader 82, a detector 83, a checker/corrector 84, a memory 85, and a presenter 86. The CPU 21 executes the information processing program to function as the acquirer 81, the reader 82, the detector 83, the checker/corrector 84, the memory 85, and the presenter 86.

The acquirer 81 acquires image data obtained by reading a document. The image data according to this exemplary embodiment may be any image data as long as the image data is related to a document including texts, such as an invoice, an application form, or a receipt.

The reader 82 executes OCR on the acquired image data to acquire results of reading of the texts in the image data (document). The reading results according to this exemplary embodiment are obtained by reading the texts in the image data and extracting the read texts as character codes. The text read from the image data according to this exemplary embodiment is an example of “extracted text”.

The detector 83 executes the application check to detect an error in the read texts. Specifically, the application check involves comparing the read texts with predetermined rules and detecting an error by determining whether the read texts conform to the predetermined rules. The error detected by the application check is hereinafter referred to as “application check-based error”. The application check-based error is an example of an inadequacy detected by the system.

The predetermined rules according to this exemplary embodiment include a rule related to consistency in a numerical value, a rule related to consistency in a date, and a rule related to correspondence between an item and a text in a document.

The rule related to consistency in a numerical value is used for determining whether the numerical value read as a text is appropriate. For example, the rule related to consistency in a numerical value is used for determining whether the acquired numerical value is a positive integer, whether the numerical value falls within or out of a predetermined range, or whether the total value among a plurality of items agrees with a value of a different item.

The rule related to consistency in a date is used for determining whether a year, month, day, and time read as a text are appropriate. For example, the rule related to consistency in a date is used for determining whether the acquired year, month, day, and time are after a predetermined year, month, day, and time, before the predetermined year, month, day, and time, fall within a predetermined range, or fall out of the predetermined range, or whether the acquired year, month, day, and time agree with the predetermined year, month, day, and time.

The rule related to correspondence between an item and a text is used for determining whether the acquired text conforms to a predetermined rule. For example, the rule related to correspondence between an item and a text is used for determining whether a text is written in a required item, or whether, if a text is written in a predetermined item, a text is also written in an associated item. The rule related to correspondence between an item and a text may also be used for determining whether a text written in a given item is in a predetermined text list.

The checker/corrector 84 receives correction of a read text, a message from the user about the read text (hereinafter referred to as “user message”), and a report that the read text has an inadequacy. For example, if the user checks the displayed read text and finds an inadequacy in the image data and the read text, the checker/corrector 84 receives a user message and a report about the inadequacy from the user and stores the message and report in the memory 85 described later. The user's check on a reading result by sight is hereinafter referred to as “user check”. The inadequacy found and reported by the user is hereinafter referred to as “user check-based error”. The user check-based error is an example of an inadequacy found by the user. The user check-based error according to this exemplary embodiment is the inadequacy reported from the user, but is not limited thereto. For example, the user check-based error may be regarded as being present in read data returned by the user in “(4) check and correction on form discrimination” or “(5) check and correction on reading results” in FIG. 1. In this exemplary embodiment, the checker/corrector 84 receives the report about the user check-based error, but the reception of the report is not limited thereto. The user check-based error and the user message may be reported as a result of the administrator's check between “(6) application check” and “(7) data output” in FIG. 1.

The memory 85 stores image data and read texts in association with each other as data read from the image data (hereinafter referred to as “read data”). In response to detection of an application check-based error by the detector 83, the memory 85 stores a report about the application check-based error in association with the read data. In response to reception of a report about a user check-based error by the checker/corrector 84, the memory 85 stores a user message and the report about the user check-based error in association with the read data. The read data according to this exemplary embodiment includes the image data, the read texts, the report about the application check-based error, the report about the user check-based error, and the user message, but is not limited thereto. The read data may include information such as a processing status of the read data, the number of unchecked pages, the number of checked pages, and a date and time of acquisition of the read data.

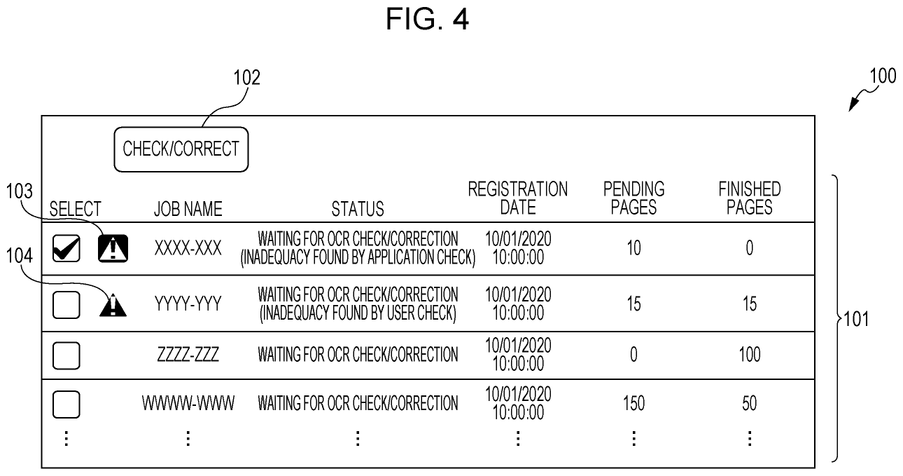

The presenter 86 presents the read data stored in the memory 85. Specifically, the presenter 86 displays a list of the read data on a list screen 100 illustrated in FIG. 4. As illustrated in FIG. 4, the list screen 100 has a list display field 101 and a “check/correct” button 102. The list display field 101 has selection checkboxes and fields for “job name”, “status”, “registration date”, “pending pages”, and “finished pages”. The selection checkbox indicates whether the user has selected read data displayed in the list display field 101. The field for “job name” indicates a name of a process on the read data. The field for “status” indicates a status of the process. The field for “registration date” indicates a date of storage of the read data. The field for “pending pages” indicates the number of pages yet to be checked by the user on image data in the read data. The field for “finished pages” indicates the number of pages checked by the user on the image data. The “check/correct” button 102 may be used for displaying details of the selected read data.

If the read data has an error, the presenter 86 displays an indication of the error in the list display field 101. Specifically, in the list screen 100 of FIG. 4, an application check-based error icon 103 or a user check-based error icon 104 is displayed on the left of a job name related to the read data. When displaying the list, the presenter 86 displays different icons such as the application check-based error icon 103 and the user check-based error icon 104 to facilitate identification of pieces of read data having respective errors. The application check-based error icon 103 and the user check-based error icon 104 are examples of a graphical object indicating inadequacy.

The presenter 86 displays read data having an application check-based error or a user check-based error at a higher place on the list screen 100 than other pieces of read data having no error. To display both the read data having the application check-based error and the read data having the user check-based error in the list, the presenter 86 positions the read data having the application check-based error at a higher place than the read data having the user check-based error. The application check-based error has the highest priority for check because of inadequacy requiring user's rechecking, such as text reading failure or inconsistency in a document that has not been found by the user by sight. The user check-based error has a priority level higher than read data having no error but lower than the read data having the application check-based error because inadequacy such as a wrong setting checked and found by the user is reported. That is, the presenter 86 displays the read data having the application check-based error, the read data having the user check-based error, and the other pieces of read data having no error in this order on the list screen 100.

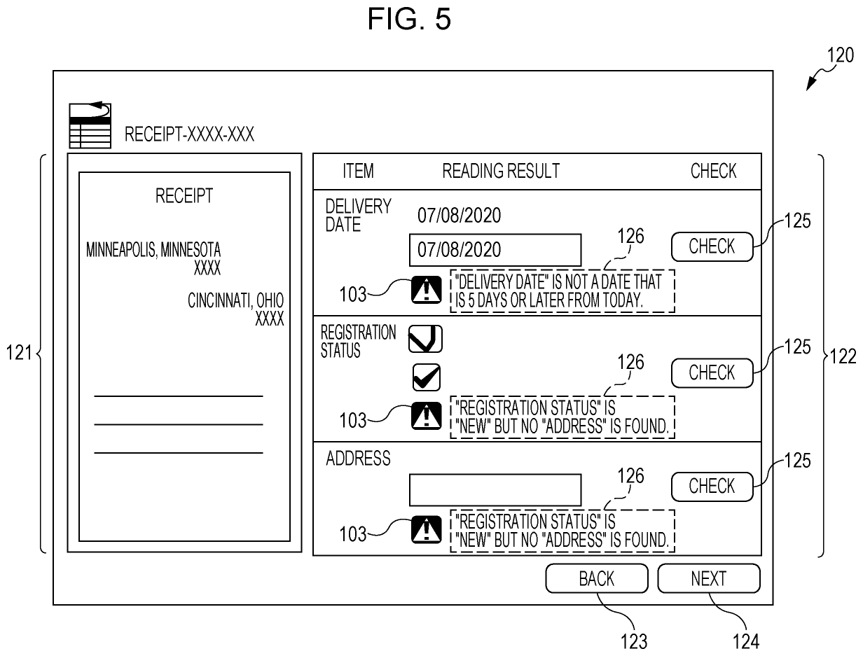

The presenter 86 displays reading results related to read data selected by the user. Specifically, the presenter 86 displays the reading result related to the selected read data in response to pressing of the “check/correct” button 102 on the list screen 100 of FIG. 4. For example, the presenter 86 displays a detail screen 120 related to check and correction in FIG. 5 in response to selection of read data and pressing of the “check/correct” button 102 on the list screen 100 of FIG. 4. The detail screen 120 has an image display field 121, a reading result display field 122, a “back” button 123, and a “next” button 124. The image display field 121 shows image data in the read data. The reading result display field 122 shows reading results related to the read data. The “back” button 123 is used for terminating check and correction on the reading results and returning to the list screen 100. The “next” button 124 is used for saving a corrected reading result and displaying reading results related to next read data. The reading result display field 122 has fields for “item” and “reading result” and check buttons 125. The field for “item” indicates a name of an item related to a text in the image data. The field for “reading result” indicates the text read from the image data and an image in an area corresponding to the read text. Each check button 125 is used for confirming whether the item has been checked.

If the read data has an application check-based error, the presenter 86 displays the reading result in the reading result display field 122 of FIG. 5 and the application check-based error icon 103 and a message 126 about the application check-based error in the field for “reading result” related to the item having the application check-based error. In this exemplary embodiment, only the item having the application check-based error is displayed on the detail screen 120 of FIG. 5, but the item to be displayed is not limited thereto. All the items related to the read data may be displayed.

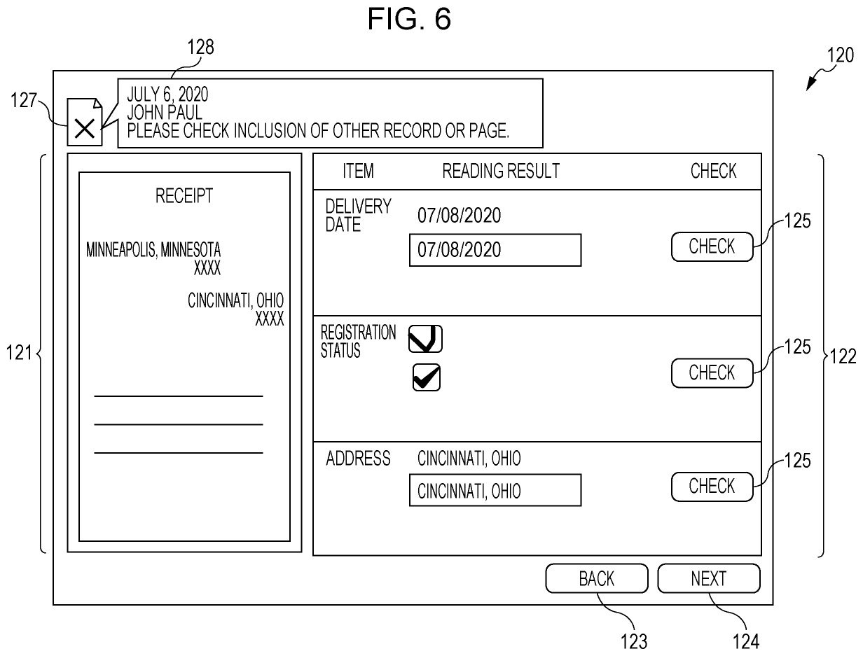

If the read data displayed on the detail screen 120 has a user check-based error, the presenter 86 displays the reading result and a user message 128 on the detail screen 120. Specifically, the presenter 86 displays the detail screen 120 related to the user check-based error as illustrated in FIG. 6. For example, the presenter 86 displays a message icon 127 on the detail screen 120 to indicate that the user message is present, and displays the user message 128 in response to pressing of the message icon 127.

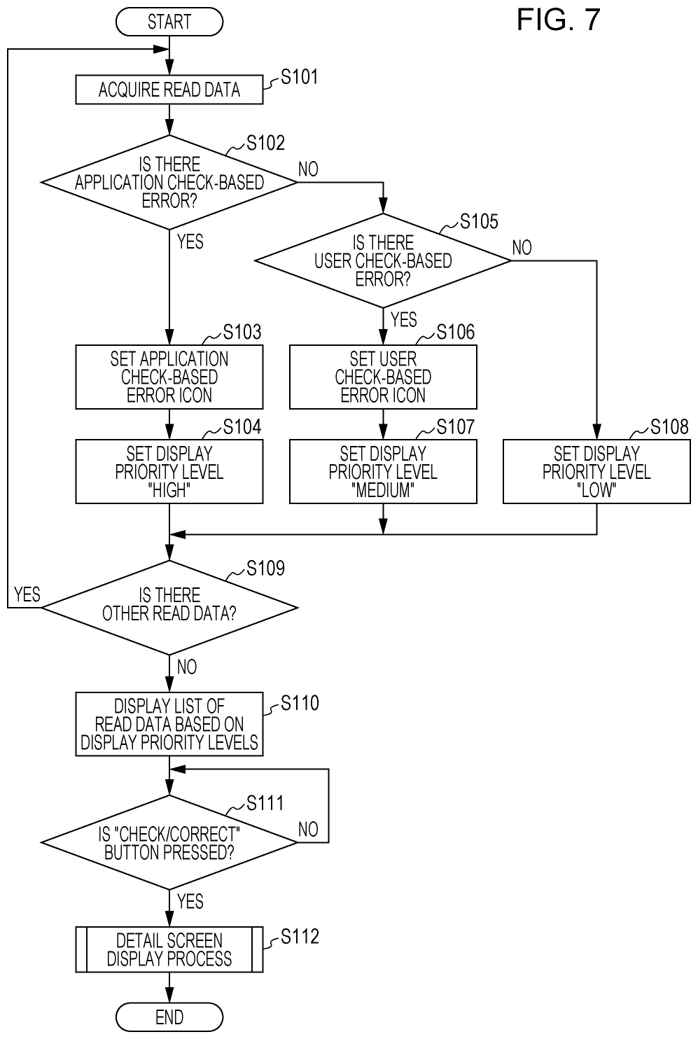

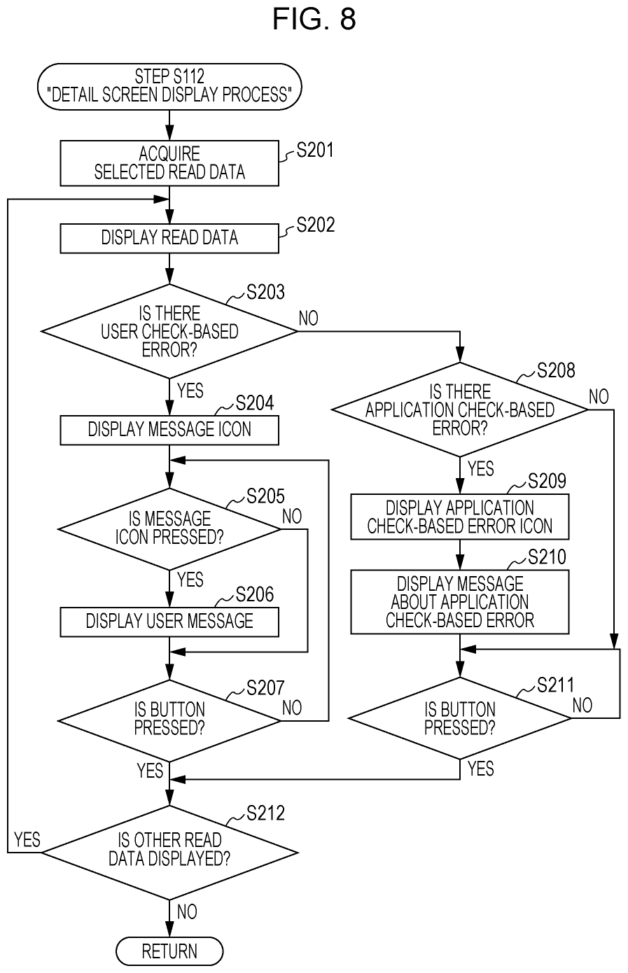

Next, the operation of the information processing apparatus 20 according to this exemplary embodiment is described with reference to FIG. 7 and FIG. 8. FIG. 7 is a flowchart illustrating an example of processes for displaying the list screen 100 according to this exemplary embodiment. The CPU 21 reads and executes the information processing program in the ROM 22 or the storage 24 to execute the processes illustrated in FIG. 7. For example, the processes illustrated in FIG. 7 are executed in response to a user's instruction to display the list.

In Step S101, the CPU 21 acquires stored read data.

In Step S102, the CPU 21 determines whether the acquired read data has an application check-based error. If the read data has the application check-based error (Step S102: YES), the CPU 21 proceeds to Step S103. If the read data has no application check-based error (Step S102: NO), the CPU 21 proceeds to Step S105.

In Step S103, the CPU 21 sets the application check-based error icon 103 for the read data.

In Step S104, the CPU 21 sets a display priority level “high” for the read data.

In Step S105, the CPU 21 determines whether the acquired read data has a user check-based error. If the read data has the user check-based error (Step S105: YES), the CPU 21 proceeds to Step S106. If the read data has no user check-based error (Step S105: NO), the CPU 21 proceeds to Step S108.

In Step S106, the CPU 21 sets the user check-based error icon 104 for the read data.

In Step S107, the CPU 21 sets a display priority level “medium” for the read data.

In Step S108, the CPU 21 sets a display priority level “low” for the read data.

In Step S109, the CPU 21 determines whether any other read data is present. If no other read data is present (Step S109: NO), the CPU 21 proceeds to Step S110. If any other read data is present (Step S109: YES), the CPU 21 proceeds to Step S101 and acquires other read data.

In Step S110, the CPU 21 displays a list of the read data based on the display priority levels set for the individual pieces of read data. The pieces of read data are displayed in the list in descending order of the display priority levels, that is, in order of “high”, “medium”, and “low”. If the application check-based error icon 103 or the user check-based error icon 104 is set, the error icon is displayed in the list together with the read data.

In Step S111, the CPU 21 determines whether the “check/correct” button is pressed on the list screen 100. If the “check/correct” button is pressed (Step S111: YES), the CPU 21 proceeds to Step S112. If the “check/correct” button is not pressed (Step S111: NO), the CPU 21 waits until the “check/correct” button is pressed.

In Step S112, the CPU 21 executes a detail screen display process for displaying the detail screen 120. The detail screen display process is described in detail with reference to FIG. 8.

Next, the detail screen display process is described with reference to FIG. 8. FIG. 8 is a flowchart illustrating an example of the detail screen display process according to this exemplary embodiment. The CPU 21 reads and executes a detail screen display program in the ROM 22 or the storage 24 to execute the detail screen display process illustrated in FIG. 8. The detail screen display process illustrated in FIG. 8 is executed in response to pressing of the “check/correct” button.

In Step S201, the CPU 21 acquires selected read data.

In Step S202, the CPU 21 displays image data and reading results related to the acquired read data.

In Step S203, the CPU 21 determines whether the acquired read data has a user check-based error. If the read data has the user check-based error (Step S203: YES), the CPU 21 proceeds to Step S204. If the read data has no user check-based error (Step S203: NO), the CPU 21 proceeds to Step S208.

In Step S204, the CPU 21 displays the message icon 127.

In Step S205, the CPU 21 determines whether the message icon 127 is pressed. If the message icon 127 is pressed (Step S205: YES), the CPU 21 proceeds to Step S206. If the message icon 127 is not pressed (Step S205: NO), the CPU 21 proceeds to Step S207.

In Step S206, the CPU 21 displays the user message 128.

In Step S207, the CPU 21 determines whether the “back” button 123 or the “next” button 124 is pressed. If the “back” button 123 or the “next” button 124 is pressed (Step S207: YES), the CPU 21 proceeds to Step S212. If neither the “back” button 123 nor the “next” button 124 is pressed (Step S207: NO), the CPU 21 proceeds to Step S205.

In Step S208, the CPU 21 determines whether the acquired read data has an application check-based error. If the read data has the application check-based error (Step S208: YES), the CPU 21 proceeds to Step S209. If the read data has no application check-based error (Step S208: NO), the CPU 21 proceeds to Step S211.

In Step S209, the CPU 21 displays the application check-based error icon 103 at a portion corresponding to an item having the application check-based error.

In Step S210, the CPU 21 displays a message about the application check-based error at a portion corresponding to the item having the application check-based error.

In Step S211, the CPU 21 determines whether the “back” button 123 or the “next” button 124 is pressed. If the “back” button 123 or the “next” button 124 is pressed (Step S211: YES), the CPU 21 proceeds to Step S212. If neither the “back” button 123 nor the “next” button 124 is pressed (Step S211: NO), the CPU 21 waits until the “back” button 123 or the “next” button 124 is pressed.

In Step S212, the CPU 21 determines whether the “next” button 124 is pressed and next read data is displayed. If the next read data is displayed (Step S212: YES), the CPU 21 proceeds to Step S202 and acquires other read data. If the next read data is not displayed (the “back” button 123 is pressed) (Step S212: NO), the CPU 21 terminates the detail screen display process. If the process is terminated, the CPU 21 receives input text correction and a message, and stores the correction and the message in association with the read data.

In this exemplary embodiment, the read data having the application check-based error, the read data having the user check-based error, and the other pieces of read data having no error are displayed in this order on the list screen 100, but the order of display is not limited thereto. The read data having the user check-based error or the other pieces of read data having no error may be displayed at the top. The user may set the priority levels of read data to be displayed at higher places. Instead, the priority levels may be omitted. In this case, the pieces of read data may be displayed in order of acquisition.

In this exemplary embodiment, the read data having the application check-based error and the read data having the user check-based error are displayed on the list screen 100 with different icons, but the display method is not limited thereto. The respective pieces of read data may be displayed with different texts. For example, in the “status” field of the list screen 100 of FIG. 4, the read data having the application check-based error may be displayed with a text “inadequacy found by application check”, and the read data having the user check-based error may be displayed with a text “inadequacy found by user check”.

In this exemplary embodiment, the read data may have the application check-based error or the user check-based error, but is not limited thereto. One piece of read data may have both the application check-based error and the user check-based error. In this case, the application check-based error icon 103 may be displayed in the list by giving a higher priority level to the application check-based error. Alternatively, the user check-based error icon 104 may be displayed in the list by giving a higher priority level to the user check-based error. Alternatively, the user may set the priority levels.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In this exemplary embodiments, the information processing program is installed in the storage, but the method for providing the information processing program is not limited thereto. The information processing program according to this exemplary embodiments may be provided by being recorded in a computer readable storage medium. For example, the information processing program according to this exemplary embodiments may be provided by being recorded in a compact disc (CD)-ROM, a digital versatile disc (DVD)-ROM, or other optical discs. The information processing program according to this exemplary embodiments may be provided by being recorded in a universal serial bus (USB) memory, a memory card, or other semiconductor memories. The information processing program according to this exemplary embodiments may be acquired from an external apparatus via a communication network connected to the communication I/F.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire data including texts extracted from an image obtained by reading a document; and
display an inadequacy in the data checked by a user and an inadequacy in the data detected by a system in different formats.

2. The information processing apparatus according to claim 1, wherein the processor is configured to:
display a list of acquired pieces of data; and
display data having an inadequacy detected by the system at a higher place in the list than data having an inadequacy checked by the user.

3. The information processing apparatus according to claim 1, wherein the processor is configured to:
display the extracted texts; and
display inadequacy information at a portion related to an inadequacy in the text detected by the system.

4. The information processing apparatus according to claim 2, wherein the processor is configured to:
display the extracted texts; and
display inadequacy information at a portion related to an inadequacy in the text detected by the system.

5. The information processing apparatus according to claim 1, wherein an inadequacy in the text detected by the system is detected by comparing the text with a rule related to the text.

6. The information processing apparatus according to claim 2, wherein an inadequacy in the text detected by the system is detected by comparing the text with a rule related to the text.

7. The information processing apparatus according to claim 3, wherein the inadequacy in the text detected by the system is detected by comparing the text with a rule related to the text.

8. The information processing apparatus according to claim 4, wherein the inadequacy in the text detected by the system is detected by comparing the text with a rule related to the text.

9. The information processing apparatus according to claim 5, wherein the rule comprises at least one of a rule related to consistency in a numerical value, a rule related to consistency in a date, or a rule related to correspondence between items and the texts in the document.

10. The information processing apparatus according to claim 6, wherein the rule comprises at least one of a rule related to consistency in a numerical value, a rule related to consistency in a date, or a rule related to correspondence between items and the texts in the document.

11. The information processing apparatus according to claim 7, wherein the rule comprises at least one of a rule related to consistency in a numerical value, a rule related to consistency in a date, or a rule related to correspondence between items and the texts in the document.

12. The information processing apparatus according to claim 8, wherein the rule comprises at least one of a rule related to consistency in a numerical value, a rule related to consistency in a date, or a rule related to correspondence between items and the texts in the document.

13. The information processing apparatus according to claim 1, wherein the different formats comprise at least one of different graphical objects and different texts indicating the inadequacies.

14. The information processing apparatus according to claim 2, wherein the different formats comprise at least one of different graphical objects and different texts indicating the inadequacies.

15. The information processing apparatus according to claim 3, wherein the different formats comprise at least one of different graphical objects and different texts indicating the inadequacies.

16. The information processing apparatus according to claim 4, wherein the different formats comprise at least one of different graphical objects and different texts indicating the inadequacies.

17. The information processing apparatus according to claim 5, wherein the different formats comprise at least one of different graphical objects and different texts indicating the inadequacies.

18. The information processing apparatus according to claim 6, wherein the different formats comprise at least one of different graphical objects and different texts indicating the inadequacies.

19. The information processing apparatus according to claim 7, wherein the different formats comprise at least one of different graphical objects and different texts indicating the inadequacies.

20. A non-transitory computer readable medium storing an information processing program causing a computer to execute a process comprising:
acquiring data including texts extracted from an image obtained by reading a document; and
displaying an inadequacy in the data checked by a user and an inadequacy in the data detected by a system in different formats.
